(19) United States
(12) Patent Application Publication
(10) Pub. No.: US 2010/0127945 A1
(43) Pub. Date: May 27, 2010

(54) Apparatus for compensation of the impedance and the load phase of the antenna element

(75) Inventors: Seppo Rousu, Oulu (FI); Marko Leinonen, Haukipudas (FI)

Correspondence Address: HARRINGTON & SMITH, 4 RESEARCH DRIVE, Suite 202, SHELTON, CT, 06484-6212, US

(73) Assignee: NOKIA CORPORATION, Espoo (FI)

(21) Appl. No.: 12/449,264

(22) PCT Filed: Jan. 31, 2007
(86) PCT No.: PCT/IB2007/001363

§ 371 Date: Jul. 30, 2009

(51) Int. Cl. H01Q 9/00

(52) U.S. Cl. 343/745

(57) ABSTRACT

An apparatus including an antenna element having an impedance and a load phase; a phase shifter coupled to the antenna element; and a controller for controlling, in response to a change in a context of the apparatus, the phase shifter to compensate for a consequent change in the impedance and the load phase of the antenna element.

### FIELD OF THE INVENTION

Embodiments of the present invention relate to an apparatus. In particular, they relate to a radio communication apparatus.

### BACKGROUND TO THE INVENTION

Apparatus such as mobile cellular telephones usually have at least one antenna element by which they can communicate with other apparatus. If the context of the apparatus changes, the load phase and impedance of the antenna element at a desired frequency band may change. For example, if a user handles the apparatus, the antenna element may electromagnetically couple with the user and the load phase and the impedance of the antenna element at the desired frequency band may change as a consequence.

One problem associated with such an apparatus is that it may no longer be able to communicate efficiently in the desired frequency band.

Mobile cellular telephone operators usually require that a mobile cellular telephone within their network meet certain Total Transmission Power (TRP) and Total Received Sensitivity (TRS) requirements. When the context of a mobile cellular telephone changes, the TRP and TRS values for the mobile cellular telephone may change and no longer meet these requirements. Currently, in order to compensate for such changes in the TRP value, additional electrical energy may be supplied to the antenna element. This may result however in the battery life of the mobile cellular telephone being reduced.

Therefore, it would be desirable to provide an alternative apparatus.

### BRIEF DESCRIPTION OF THE INVENTION

According to one embodiment of the present invention there is provided an apparatus comprising: an antenna element having an impedance and a load phase; a phase shifter coupled to the antenna element; and a controller for controlling, in response to a change in a context of the apparatus, the phase shifter to compensate for a consequent change in the impedance and the load phase of the antenna element.

When the apparatus is in a first context, the antenna element may have a first load phase and a first impedance. When the context of the apparatus changes to a second context, the phase shifter may compensate for the consequent change in the load phase and impedance of the antenna element by bringing the load phase and the impedance of the antenna element towards the first load phase and the first impedance.

The context of the apparatus may be a physical environment of the apparatus. The context of the apparatus may be a physical mode of the apparatus.

The apparatus may further comprise one or more sensors for detecting the context of the apparatus and for providing detection information to the controller for identification of the context of the apparatus. The one or more sensors may be operable to detect the proximity of an object which is external to the apparatus.

The controller may be operable to detect and subsequently identify, using the detection information, the context of the apparatus. The controller may be operable to detect an operational mode of the apparatus. The apparatus may further comprise a memory for storing a database having information associated with at least one context of the apparatus. The controller may be operable to identify the context of the apparatus by comparing the detection information with the information in the database.

The predetermined information in the database may include phase shift information for at least one context.

The controller may be operable to control the phase shifter using the phase shift information in the database. The phase shifter may be coupled to the antenna element via a feed point of the antenna element. The phase shifter may be alternatively coupled to the antenna element via a ground point of the antenna element.

According to another embodiment of the present invention there is provided a method comprising: controlling, in response to a change in a context of an apparatus, including an antenna element, having an impedance and a load phase, and a phase shifter coupled to the antenna element, the phase shifter to compensate for a consequent change in the impedance and the load phase of the antenna element.

When the apparatus is in a first context, the antenna element may have a first load phase and a first impedance and when the context of the apparatus changes to a second context, the method may further comprise compensating for the consequent change in the load phase and the impedance of the antenna element by bringing the load phase and the impedance of the antenna element towards the first load phase and the first impedance.

The context of the apparatus may relate to the physical environment of the apparatus. The context of the apparatus may be a physical mode of the apparatus.

The method may further comprise detecting, via one or more sensors, the context of the apparatus and providing information to a controller of the apparatus.

The method may further comprise identifying, at the controller, the context of the apparatus using the detected information.

The one or more sensors may be operable to detect the proximity of an object which is external to the apparatus.

The method may further comprise detecting, at a controller, the context of the apparatus. The controller may be operable to detect an operational mode of the apparatus.

The method may further comprise identifying, at the controller, the context of the apparatus using the detection information.

The method may further comprise storing a database having information associated with at least one context of the apparatus. The method may further comprise comparing the detection information with the information in the database to identify the context of the apparatus.

The predetermined information in the database may include phase shift information for at least one context. The phase shifter may be controlled by using the phase shift information in the database.

According to further embodiment of the present invention, there is provided a computer program comprising program instructions for causing a computer to perform the method as described in the above paragraphs.

According to another embodiment of the present invention, there is provided a computer program comprising program instructions for controlling the load phase and impedance of an antenna element and comprising means for controlling, in response to a change in a context of an apparatus, including an antenna element, having a load phase and an impedance, and a phase shifter coupled to the antenna element, the phase shifter to compensate for a consequent change in the load phase and impedance of the antenna element.

According to a further embodiment of the present invention, there is provided a physical entity embodying the computer program as described in the above paragraphs.

According to another embodiment of the present invention, there is provided an electromagnetic carrier signal carrying the computer program as described in the above paragraphs.

According to a further embodiment of the present invention there is provided an apparatus comprising: an antenna element having a first resonant frequency within a first operational frequency band when in a first context; a phase shifter coupled to the antenna element; and a controller for controlling, in response to a change in a context of the apparatus, the phase shifter to change the resonant frequency of the antenna element to a second resonant frequency within the first operational frequency band.

### BRIEF DESCRIPTION OF THE DRAWINGS

For a better understanding of the present invention reference will now be made by way of example only to the accompanying drawings in which:

FIG. 1 illustrates a schematic diagram of an apparatus according to an embodiment of the present invention;

FIG. 2 illustrates a flow diagram of a method according to an embodiment of the present invention;

FIG. 3 illustrates a schematic diagram of an apparatus according to another embodiment of the present invention;

FIG. 4 illustrates a graph of antenna load phase versus the receiver sensitivity and antenna load phase versus the overall Voltage Standing Wave Ratio of the receiver;

FIG. 5 illustrates a schematic diagram of an apparatus according to another embodiment of the present invention;

FIG. 6 illustrates a schematic diagram of an apparatus according to a further embodiment of the present invention;

FIG. 7 illustrates a schematic diagram of an apparatus according to another embodiment of the present invention;

FIG. 8 illustrates a schematic diagram of an apparatus according to a further embodiment of the present invention; and

FIG. 9 illustrates a schematic diagram of an apparatus according to another embodiment of the present invention.

### DETAILED DESCRIPTION OF EMBODIMENTS OF THE INVENTION

The figures illustrate an apparatus 10 comprising: an antenna element 24 having an impedance and a load phase; a phase shifter 30 coupled to the antenna element 24; and a controller 12 for controlling, in response to a change in a context of the apparatus 10, the phase shifter 30 to compensate for a consequent change in the impedance and the load phase of the antenna element 24.

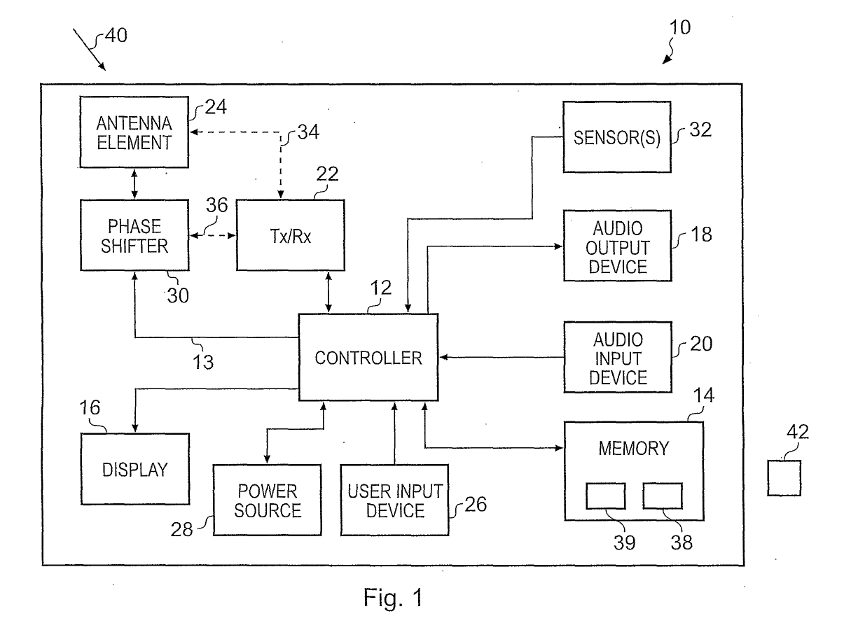

FIG. 1 illustrates a schematic diagram of one embodiment of an apparatus 10 according to the present invention. In more detail, the apparatus 10 includes a controller 12, a memory 14, a display 16, an audio output device 18, an audio input device 20, a transceiver 22, an antenna element 24, a user input device 26, a power source 28, a phase shifter 30 and one or more sensors 32.

The apparatus 10 may be any electronic device and may be, for example, a portable apparatus such as a mobile cellular telephone, Personal Digital Assistant (PDA) or laptop computer. In the following embodiment which is described in detail with reference to FIG. 1, the apparatus 10 is a mobile cellular telephone.

The controller 12 may be any suitable processor and is, in this embodiment, a microprocessor. The controller 12 is connected to read from and write to the memory 14. The memory 14 may be any suitable memory and may be, for example, permanent built-in memory such as flash memory or it may be a removable memory such as a hard disk, secure digital (SD) card or a micro-drive.

The display 16 is coupled to the controller 12 for receiving and displaying data. The controller 12 may read data from the memory 14 and provide it to the display 16 for display to a user of the cellular telephone 10. The display 16 may be any suitable display and may be for example, a thin film transistor (TFT) display or a liquid crystal display (LCD).

The controller 12 is arranged to provide audio data to the audio output device 18. The audio output device 18 is arranged to convert the audio data into acoustic waves, audible to the user of the cellular telephone 10. The audio output device 18 may be, for example, a loudspeaker.

The audio. input device 20 is arranged to convert acoustic waves (for example, a voice of a user) into an electrical signal for input to the controller 12. The audio input device 20 is in this embodiment a microphone.

The transceiver 22 is connected to the antenna element 24 and to the controller 12. The transceiver 22 includes radio frequency portions of the transmitter and receiver which are not illustrated in this figure. The controller 12 is arranged to provide data to the transceiver 22. The transceiver 22 is arranged to encode the data and provide it to the antenna element 24 for transmission. The antenna element 24 is arranged to transmit the encoded data as a radio signal.

The antenna element 24 is also arranged to receive a radio signal. The antenna arrangement 24 then provides the received radio signal to the transceiver 22 which decodes the radio signal into data. The transceiver 22 then provides the data to the controller 12.

It should be appreciated that the antenna element 24 may be a part of an antenna arrangement which includes a plurality of antenna elements. Each of the antenna elements in the antenna arrangement may be arranged in accordance with embodiments of the invention. The antenna element 24 may be any suitable antenna element and may be a monopole antenna, a dipole antenna, a helical antenna, a planar inverted F antenna (PIFA), a planar inverted L antenna (PILA) or a loop antenna. If the antenna element 24 is part of an antenna arrangement, it should be appreciated that the antenna arrangement may include any combination of the above antenna types.

The user input device 26 is operable by a user of the mobile cellular telephone to provide a control signal to the controller 12. The user input device 26 may be any suitable device and may be a keypad in one embodiment.

The power source 28 is configured to provide electrical power to each of the components of the apparatus 10. The controller 12 is operable to control the supply of electrical power from the power source 28 to the components of the apparatus 10. In the embodiment where the apparatus 10 is a mobile cellular telephone the power source 28 is a battery.

The phase shifter 30 may be connected to the antenna element 24 via a feed point or a ground point of the antenna element 24. If the phase shifter 30 is connected to a ground point of the antenna element 24 then the phase shifter 30 is not connected directly to the transceiver 22. In this embodiment, data is exchanged between the controller 12 and the antenna element 24 via the transceiver 22 only (indicated by dotted line 34). If the phase shifter 30 is connected to the feed point of the antenna element 24 then the phase shifter 30 is also connected to the transceiver 22. In this embodiment, data is exchanged between the controller 12 and the antenna element 24 via the transceiver 22 and the phase shifter 30 (indicated by dotted line 36).

Phase shifters are well known within the art of radio frequency circuitry and will not be discussed in detail here. Phase shifters may comprise, among other things, a plurality of transmission lines or comprise lumped components. Phase shifters can also be realised with active components such as transistor circuitry. Phase shifters are configured so that as they are switched between different configurations (for example, as they are switched between different lengths of transmission lines), they change the load phase of the antenna element to which they are connected. If a phase shifter is operating in a theoretically optimum way, then only the phase of the impedance of the antenna element is changed. However, since phase shifters are implemented with actual physical components there will always be an impedance change of the antenna element.

The one or more sensors 32 are connected to the controller 12 and are operable to detect the context of the apparatus 10 and provide the detection information to the controller 12. In other embodiments of the invention, the controller 12 may be operable to detect the context of the apparatus 10.

The context of the apparatus 10 may be defined by the physical environment of the apparatus 10, for example, the proximity and spatial distribution of objects external to the apparatus 10. In this embodiment, the one or more sensors 32 are proximity sensors. The context of the apparatus may also be defined by the operating mode of the apparatus 10. For example, in the embodiment where the apparatus is a mobile cellular telephone, the context of the apparatus may be defined by the radio frequency protocol the apparatus is communicating in (for example, GSM, WCDMA, DVBH etc. . . . ). The context of the apparatus may also be defined by the physical mode of the apparatus. For example, if the apparatus is a mobile phone with a sliding mechanism, swivel mechanism or flip mechanism, then one physical mode may be the physical position of the slide mechanism, swivel mechanism or flip mechanism. The physical mode of the apparatus may be detected by the controller 12 or sensors 32 (e.g. HAL sensors).

The memory 14 stores computer program instructions 38 that control the operation of the apparatus 10 when loaded into the controller 12. The computer program instructions 38 provide the logic and routines that enables the controller 12 to perform the method described in the following paragraphs of the description.

The computer program instructions may arrive at the apparatus 10 via an electromagnetic carrier signal 40 or be copied from a physical entity 42 such as a computer program product, a memory device or a record medium.

The memory 14 also stores a database 39 which includes information for at least one context of the apparatus 10. The controller 12 can interrogate the database 39 to identify the context of the apparatus 10 by comparing the detection information (obtained from the sensors 32 or obtained by the controller 12) with the information in the database. The database 39 also includes phase shift information for each context. The use of the database 12 will be explained in greater detail in the following paragraphs.

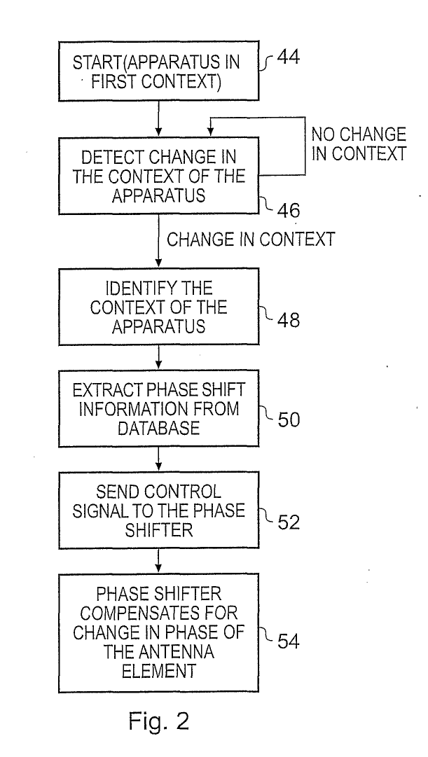

FIG. 2 illustrates a flow diagram of a method according to an embodiment of the present invention. Initially at step 44, the apparatus 10 is in a first context. The phase shifter 30 is in a first configuration and consequently, the antenna element 24 has a first load phase and a first impedance at a first operational frequency band. The first load phase and first impedance are optimum for the antenna element 24 when operating in the first operational frequency band. At the first load phase and first impedance, the antenna element 24 resonates efficiently in the first operational frequency band because the capacitive and inductive components of the antenna element's 24 impedance effectively cancel one another out and the antenna element 24 becomes substantially only resistive. Consequently, the apparatus 10 consumes less electrical power from the power source 28 to transmit a signal. Additionally, at the first load phase and first impedance, the antenna element 24 receives signals more efficiently.

At step 46, the sensors 32 and/or the controller 12 check to see if there has been a change in the context of the apparatus 10. If there has not been a change in the context of the apparatus, then step 46 is repeated. If there has been a change in the context of the apparatus 10, then the sensors 32 and/or the controller 12 detect the change and provide detection information to the controller 12.

The sensors 32 and/or controller 12 may check to see if there has been a change in the context of the apparatus at predefined time intervals (for example, 5 seconds or 1600 times per second if it is performed at the base rate). In some embodiments, the sensors 32 and/or controller 12 may check at variable time intervals depending on the context of the apparatus. For example, if they detect that the context of the apparatus is likely to change frequently, they may decrease the time between the time intervals.

The proximity sensors 32 are arranged to detect the proximity and spatial distribution of objects which are external to the apparatus 10. For example, the proximity sensors 32 may be arranged to detect if the user has placed the apparatus 10 next to his cheek (which is usually the case when the user is making a phone call on the apparatus) or if the user is holding the apparatus 10 in his hand away from his cheek (which is usually the case when the user is watching a film or television on the apparatus).

The controller 12 is arranged to detect if the operating mode of the apparatus 10 changes. For example, the controller 12 may detect if the operational mode of the apparatus 10 changes from a GSM voice call to a GSM data call. Additionally, the controller 12 can detect a change in the context of the apparatus 10 by measuring the power level of the power source 28. If the electrical power output by the power source 28 increases, this may indicate that the load phase and impedance of the antenna element 24 (and in one embodiment, the impedance of the antenna element 24) have changed and that the antenna element 24 requires more electrical power to transmit a given signal. Such a change in the load phase and impedance of the antenna element 24 may indicate a change in the context of the apparatus 10.

The load phase and impedance of the antenna element 24 at the first operational frequency band may change (due to a change in the context of the apparatus 10) so that they are no longer equal to the first load phase and first impedance respectively (i.e. the load phase of the antenna element 24 at the first operational frequency band is shifted away from the first load phase and the impedance of the antenna element 24 at the first operational frequency band is shifted away from the first impedance). For example, the load phase and impedance of the antenna element 24 may change if the apparatus 10 is moved to a position adjacent the user's cheek. The change in the load phase of the antenna element 24 may reduce the power of an output signal from the antenna element 24 and/or increase the power consumption of the antenna element 24.

In step 48, the controller 12 interrogates the database 39 and compares the detection information (obtained in step 46) with the information in the database 39 to identify the current context of the apparatus 10. For example, the sensors 32 may detect that the apparatus 10 is placed in proximity to an object which is adjacent the user input device 26 of the apparatus (e.g. the keypad). When the controller 12 receives this detection information and interrogates the database 39, it identifies that the apparatus 10 has been placed next to the user's cheek. As another example, the controller 12 may detect that the operational mode of the apparatus 10 has been changed from GSM voice call to GSM data call. When the controller 12 subsequently interrogates the database 39 and compares the detection information with the information in the database 39, it identifies that the apparatus 10 is now being held in the user's hand away from the user's cheek.

The controller 12 may identify the following contexts of the apparatus 10: a voice call (via GSM, WCDMA and other protocols), a data call (via GSM, GPRS, EGPRS, WCDMA and other protocols), watching television content on the apparatus 10, phone call with phone located on user's cheek, phone call with wireless headset, phone call with wired headset, phone call with integrated hands free speaker.

Once the context of the apparatus 10 has been identified, the controller 12 then extracts phase shift information for the identified context from the database 39 at step 50. The phase shift information identifies the phase shift necessary for bringing the load phase and impedance of the antenna element 24 towards (and preferably at) the first load phase and the first impedance.

If the controller 12 determines that the load phase and impedance of the antenna element 24 have not substantially changed (for example, above a predetermined threshold) and it is not worth controlling the phase shifter 30 to change its configuration, the controller 12 goes back to step 46.

At step 52, the controller 12 sends a control signal to the phase shifter 30 to change the phase shifter 30 to a second configuration. At step 54, the phase shifter 30 compensates for the change in the load phase and impedance of the antenna element 24. The change in the configuration of the phase shifter 30 to the second configuration changes the load phase and impedance of the antenna element 24 to compensate for the change in the load phase and impedance due to the change in context. The second configuration of the phase shifter 30 brings the load phase and impedance of the antenna element 24 towards (and preferably at) the first load phase and the first impedance.

In one embodiment, the accuracy of the compensation performed by the phase shifter 30 is dependent upon the detected context of the apparatus 10. For example, in some contexts only a minimal performance improvement may be needed and the accuracy of the compensation performed by the phase shifter 30 may be ±30 degrees. In other contexts, the performance improvement may be important and the accuracy of the compensation performed by the phase shifter 30 is less than ±30 degrees and may be less than ±5 degrees.

Embodiments of the present invention provide an advantage in that since the phase shifter 30 compensates for the change in the load phase and impedance of the antenna element 24 due to the change in the context of the apparatus 10, the antenna element 24 is more efficient when transmitting and receiving signals. This may help to reduce the power consumption of the antenna element 24 and enable the apparatus 10 to achieve the required TRP and TRS values irrespective of its context.

The phase shifter 30 may be enabled at certain predetermined power levels depending on whether the antenna element 24 is receiving or transmitting a signal. For example, the phase shifter 30 may be enabled if the antenna element 24 is transmitting above a threshold power level (in order to conserve battery power) or it may be enabled if the antenna element 24 is expected to receive a signal below a threshold power level (so that it may receive the signal).

In one embodiment, the load phase and impedance for the optimum current consumption of the antenna element 24 and the load phase and impedance for the optimum antenna performance may not be the same. The controller 12 (or the user of the apparatus 10 via a software application) is arranged determine whether the load phase should be controlled to optimise the current consumption or optimise the antenna performance based on its knowledge of the context of the apparatus.

In another embodiment, the controller 12 may detect that the apparatus 10 is operating simultaneously in two or more similar operational frequency bands using two or more different antenna elements. In this embodiment, the controller 12 controls the phase shifter 30 to change the load phase and impedance of the antenna element 24 so that one of the antenna elements is resonant at a different frequency but within the same operational frequency band. This may help to reduce the interference between the two antenna elements.

For example, the antenna element 24 may be operating at GSM 850 or at GSM 900 and the controller 12 may detect that the user has requested that television content be downloaded via another antenna (not illustrated) using DVBH which has a similar operational frequency band (470 to 702 MHz). DVB-H is a mobile television standard which will be widely deployed within the next few years. DVB-H is an evolution of the European DVB-T digital television standard. The operational frequencies for DVB-T are from 470 MHz to 862 MHz. In this embodiment, the controller 12 controls the phase shifter 30 to change the load phase of the antenna element 24 so that it continues to operate in the GSM 850 band or in the GSM 900 band but at a different resonant frequency which does not substantially interfere with the download of the television content.

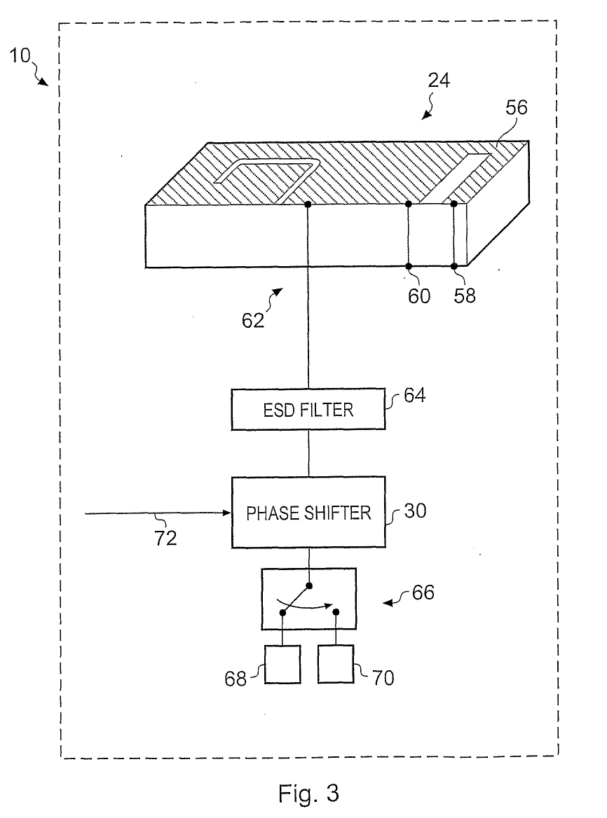

FIG. 3 illustrates a schematic diagram of another embodiment of the present invention. In this embodiment, the antenna element 24 includes a planar element 56, a feed point 58, a ground point 60 and an additional ground point 62. The additional ground point 62 is connected to an ESD filter 64 which is in turn connected to the phase shifter 30. The phase shifter 30 is connected to a switching circuit 66 which is in turn connected to a first transmission line 68 and a second transmission line 70. The remaining components (such as the controller 12) of the apparatus 10 are not illustrated to maintain the clarity of FIG. 3.

The switching circuit 66 (an SPDT switch in this embodiment) is configured to switch the phase shifter 30 between being connected to the first transmission line 68 and being connected to the second transmission line 70. The length of the first transmission line 68 is selected so that when the phase shifter 30 is connected to the first transmission line 68, the antenna element 24 is effectively connected to an open circuit at the additional ground point 62. The length of the second transmission line 70 is selected so that when the phase shifter 30 is connected to the second transmission line 70, the antenna element 24 is effectively connected to a closed circuit at the additional ground point 62.

The antenna element 24 is arranged so that it is operable in two resonant modes. When the phase shifter 30 is connected to the first transmission line 68, the antenna element 24 is operable in the GSM 850 and GSM 1900 bands. When the phase shifter 30 is connected to the second transmission line 70, the additional ground point 62 changes the resonant modes of the antenna 24 so that it is operable in the GSM 900 and GSM 1800 modes.

The phase shifter 30 is arranged to receive control signals (indicated by arrow 72) from the controller 12 (illustrated in FIG. 1). If the context of the apparatus 10 changes, the controller 12 can control the phase shifter 30 to compensate for the consequent change in the load phase and impedance of the antenna element 24 in each of the four resonant modes mentioned above.

This embodiment provides an advantage in that since the phase shifter 30 is connected to the additional ground point 62, it does not introduce an additional insertion loss between the antenna element 24 and the transceiver 22. Consequently, the antenna element 24 may operate more efficiently.

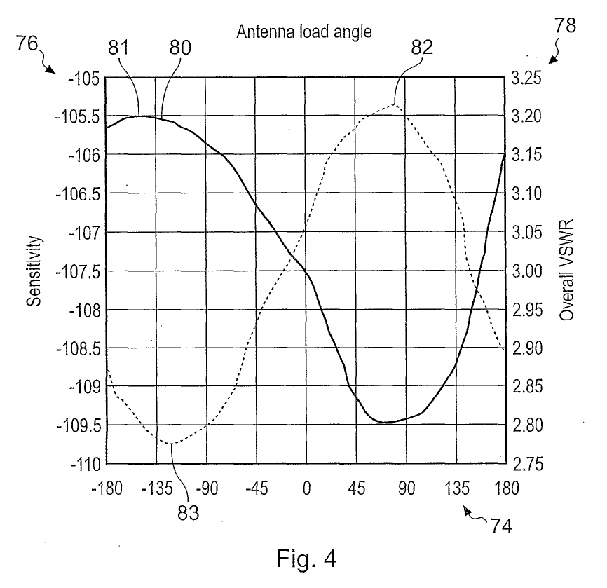

FIG. 4 illustrates a graph of antenna load phase versus the receiver sensitivity and antenna load phase versus the overall Voltage Standing Wave Ratio of the receiver. The graph includes a horizontal axis 74 for the antenna load phase angle and includes values from −180° to 180°. The graph also includes a vertical axis 76 for the receiver sensitivity and a vertical axis 78 for the standing wave ratio of the receiver. A solid line 80 represents a plot of the receiver sensitivity over the range of the antenna load phase angle and has a sinusoidal shape. At −180° the solid line 80 initially rises to a maxima 81 (at approximately −135°) and falls to a minima at approximately 60°. A dotted line 82 represents a plot of the receiver standing wave ratio over the range of the antenna load phase angle and also has a sinusoidal shape. At −180° the dotted line 82 initially starts at a position where it is falling towards a minima 83 at approximately −100° and then rises to a maxima at approximately 80°.

The receiver standing wave ratio represents the extent to which an incoming signal is reflected back to an antenna port. The standard wave ratio can be considered as a loss for the received signal path which degrades the receiver reception performance.

Advantages which are provided by embodiments of the present invention can be understood from FIG. 4. In FIG. 4, the first load phase mentioned above is approximately equal to the load phase at the minima 83 of the dotted line 82. At this point, the sensitivity of the receiver indicated by the solid line 80 is also near its maxima 81. If the context of the apparatus 10 changes, the load phase of the antenna element 24 changes so that it is no longer equal to the first load phase (and hence the impedance of the antenna element 24 is no longer equal to the first impedance). As can be appreciated from FIG. 4, if the load phase of the antenna element 24 changes, the standing wave ratio of the receiver increases and the sensitivity of the receiver decreases. This may result in a degradation in the performance of the receiver. Embodiments of the invention provide an advantage because the phase shifter 30 may shift the load phase and impedance towards the first load phase and the first impedance and thereby decrease the standing wave ratio and increase the sensitivity of the receiver. A similar graph to the one illustrated in FIG. 4 may be plotted for the performance of a transmitter.

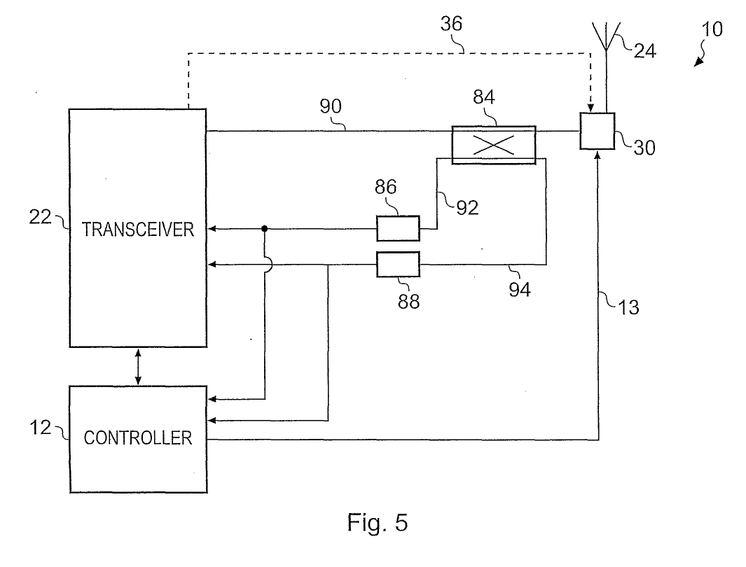

Fig, 5 illustrates a schematic diagram of an apparatus 10 according to another embodiment of the present invention. The apparatus 10 is similar to the apparatus illustrated in FIG. 1 and where features are similar, the same reference numerals are used. In this embodiment, the apparatus 10 includes a directional coupler 84, an (optional) RF to DC rectifier 86 and an (optional) RF to DC rectifier 88 and a transmission line 90. The remaining components of the apparatus 10 are not illustrated to maintain the clarity of FIG. 5.

The transmission line 90 is connected to the transceiver 22 and to the phase shifter 30 via the directional coupler 84. The directional coupler 84 produces a signal 92 which includes a portion of a transmitted signal and a signal 94 which contains a portion of the transmitted signal which is reflected from the antenna element 24 due to load phase of the antenna element 24. The signals 92 and 94 are provided to the transceiver 22 and to the controller 12 via the rectifiers 86 and 88 which convert RF frequency information to baseband frequency information. The rectifiers 86 and 88 are optional since the controller 12 and the transceiver 22 may be able to process RF frequency information.

The controller 12 is arranged to process the signals 92 and 94 to detect if there has been a change in the load phase and impedance of the antenna element 24. The controller 12 may determine the phase shift required in order to change the load phase and impedance of the antenna element 24 to an optimum load phase and impedance and provide a control signal 13 to the phase shifter 30 to change the configuration of the phase shifter 30 to achieve the optimum load phase and impedance.

In order to achieve an optimum load phase and impedance for the antenna element 24, the controller 12 may carry out an iterative process where it controls the phase shifter 30 to rotate the phase in a first direction and then monitors the reflected power from the antenna element 24 (using signal 94). If the reflected power increases, the controller 12 controls the phase shifter 30 to rotate in a second direction (opposite to the first direction). If the reflected power decreases, the controller 12 controls the phase shifter 30 to rotate once again in the first direction. By using an iterative process, the accuracy of the compensation performed by the phase shifter 30 may be improved because the controller 12 continuously controls the phase shifter 30 towards the optimum load phase and impedance.

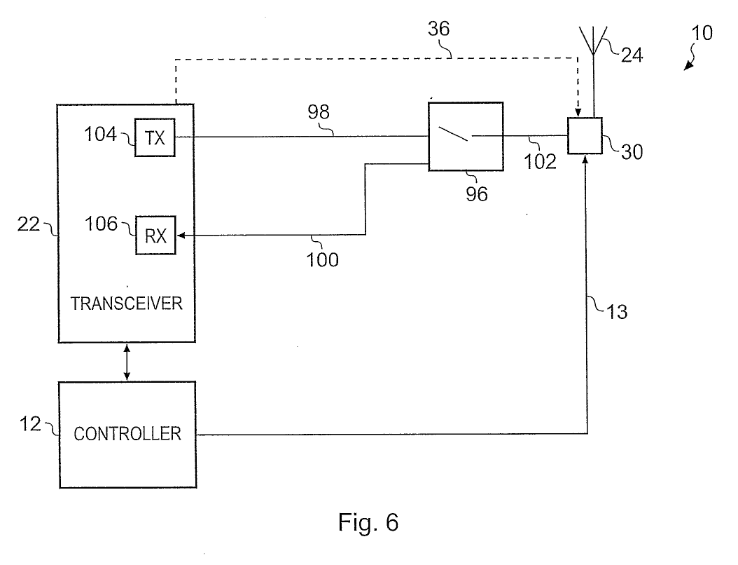

FIG. 6 illustrates an apparatus according to a further embodiment of the present invention. The apparatus 10 is similar to the apparatus illustrated in FIG. 1 and where the features are similar, the same reference numerals are used. In this embodiment, the apparatus 10 includes a switch 96, a transmission line 98, a transmission line 100 and a transmission line 102.

The transceiver 22 includes a transmitter 104 and a receiver 106. The transmitter 104 is connected to the switch 96 via the transmission line 98 and the receiver 106 is connected to the switch 96 via the transmission line 100. The switch 96 is connected to the phase shifter 30 via the transmission line 102.

When a signal is transmitted from the transmitter 104 to the antenna element 24, some of the reflected signal is leaked to the transmission line 100 (when the switch 96 connects the transmission line 100 to the phase shifter 30). The leaked signal on the transmission line 100 can be compared to the transmission signal in the transmitter 104 and the controller 12 may control the phase shifter 30 to change its configuration so that the load phase compensates for a change in the context of the apparatus 10.

The controller 12 determines if the phase shifter 30 is providing an optimum compensation for the antenna element 24 by comparing the phase and amplitude of the leaked signal on the transmission line 100 with stored optimum phase and amplitude values. If the phase and amplitude of the leaked signal are the same as the stored optimal phase and amplitude values, the controller 12 determines that the phase shifter 30 is providing optimal compensation of the load phase and impedance of the antenna element 24. The optimum antenna load phase can be determined during development of the apparatus 10 and can be stored in the memory 14. The optimum load phase value can be considered as a target value when an iterative process is performed.

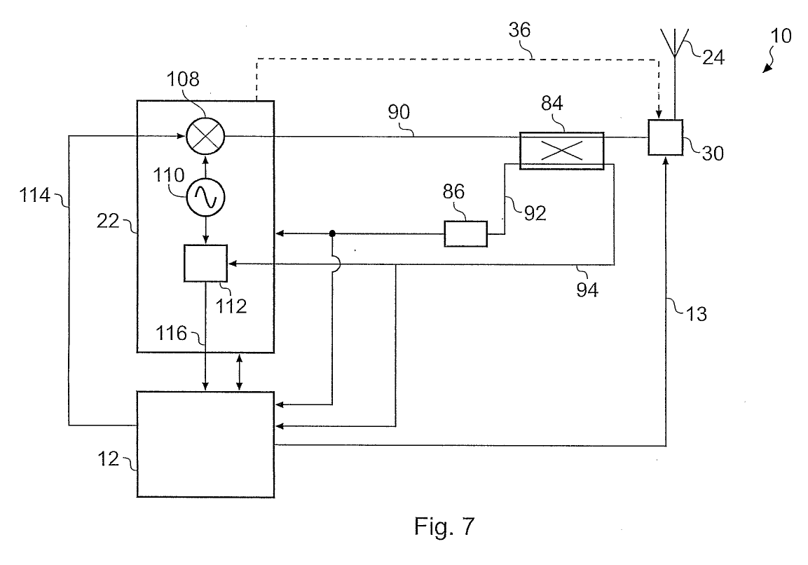

FIG. 7 illustrates an apparatus according to another embodiment of the present invention. The apparatus 10 is similar to the apparatus 10 illustrated in FIG. 5 and where the features are similar, the same reference numerals are used. In this embodiment, the transceiver 22 includes a mixer 108, a voltage controlled oscillator 110 and a phase comparator 112.

In this embodiment, the controller 12 sends transmission data 114 to the transceiver 22 where it is provided to the mixer 108 and converted to a transmission frequency (determined by the voltage controlled oscillator 110). The phase comparator 112 is arranged to compare the signal 94 (from the directional coupler 84) with the output of the voltage controlled oscillator 110 and provide an output 116 to the controller 12 which indicates the phase difference between the output of the voltage controlled oscillator 110 and the signal 94. The controller 12 processes the output 116 of the phase comparator 112 to determine how to control the phase shifter 30 to change the load phase of the antenna element 24.

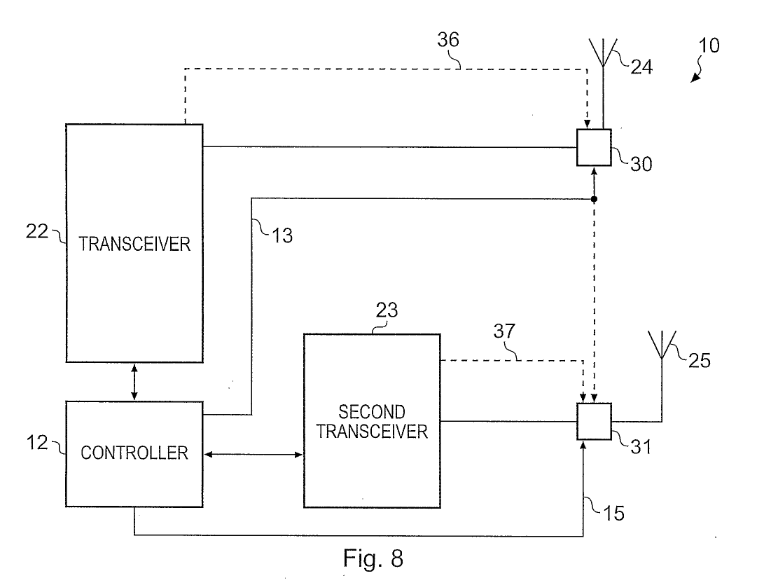

FIG. 8 illustrates an apparatus according to a further embodiment of the present invention. The apparatus 10 is similar to the apparatus illustrated in FIG. 1 and where the features are similar, the same reference numerals are used.

In this embodiment, the apparatus 10 includes a second transceiver 23, a second phase shifter 31 and a second antenna element 25. The second phase shifter 31 can be controlled by the controller 12 or by the transceiver 23 (via signals 15 and 37 respectively). The transceivers 22 and 23 may have similar functionalities and include transmitter and receiver portions. The transceiver 22 may be, for example, a GSM/WCDMA transceiver and the transceiver 23 may be WLAN transceiver. The controller 12 may control the phase shifters 30 and 31 using the same control signal 13 if they are both operating at substantially the same operational frequency band.

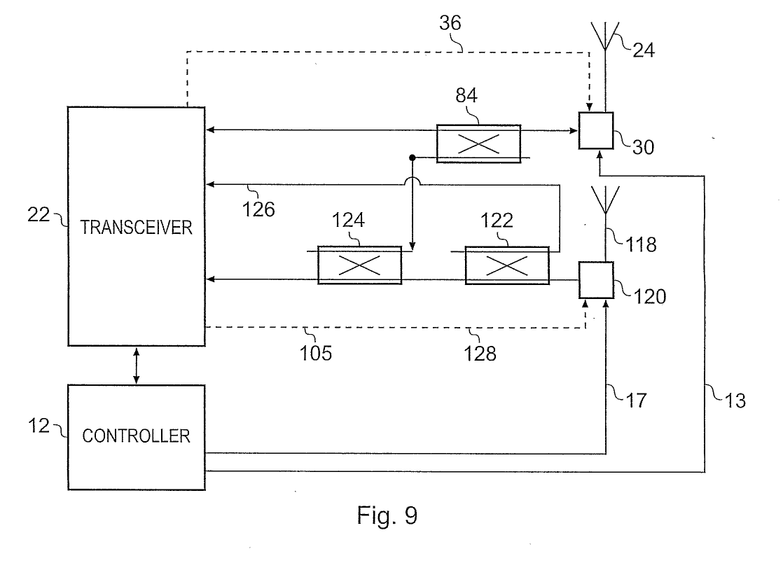

FIG. 9 illustrates an apparatus according to another embodiment of the present invention. The apparatus 10 is similar to the apparatus illustrated in FIG. 5 and where the features are similar, the same reference numerals are used. In this embodiment, the apparatus 10 includes a third antenna element 118, a third phase shifter 120, a directional coupler 122 and a directional coupler 124.

The third antenna element 118 is a diversity reception antenna and is used to increase the operational frequency range of the apparatus 10. The third antenna element 118 may be used, for example, to receive signals in a WLAN frequency band. The third antenna element 118 is connected to the transceiver 22 via the third phase shifter 120 and the directional couplers 122 and 124 and may be controlled via a signal 128.

The directional coupler 122 is arranged to detect the signal reflected from the third antenna 118 and provide it to the transceiver 22 as signal 126. The directional coupler 124 provides a portion of the signal sent to the antenna element 24 to the transceiver 22.

The transceiver 22 receives the signal 126 and compares it to the signal 128 to determine if the context of the apparatus 10 has changed. If the context of the apparatus 10 has changed, the controller 12 and the transceiver 22 can control the phase shifters 120 (via control signal 17) and 30 to compensate for the change in the context.

In order to improve the performance of the third antenna element 118, the signals received by the antenna elements 24 and 118 should be 90° phase off-set relative to one another. This can be achieved by locating the antenna elements 24 and 118 λ/4 apart from one another. Since this may not be possible in all apparatus', the phase shifter's 30 and 120 can be controlled to ensure that there is a 90° phase difference between the signals received from the antenna elements 24 and 118.

It should be appreciated that embodiments of the present invention are not limited to the resonant frequency bands mentioned above. For example, the different frequency bands and protocols may include (but are not limited to) DVB-H 470 to 702 MHz, US-GSM 850 (824-894 MHz); EGSM 900 (880-960 MHz); GPS 1572.42 MHz, PCN/DCS1800 (1710-1880 MHz); US-WCDMA1900 (1850-1990) band; WCDMA21000 band (Tx: 1920-1980I Rx: 2110-2180); PCS1900 (1850-1990 MHz); 2.5 GHz WLAN/BT, 5 GHz WLAN, DRM (0.15-30.0 MHz), FM (76-108 MHz), AM (0.535-1.705 MHz), DVB -H[US] (1670-1675 MHz), WiMax (2300-2400 MHz, 2305-2360 MHz, 2496-2690 MHz, 3300-3400 MHz, 3400-3800 MHz, 5150-5875 MHz), RFID (LF [125-134 kHz], HF[13.56 MHz]) UHF [433 MHz, 865-956 MHz or 2.45 GHz), and UWB 3.0 to 10.6 GHz.

Although embodiments of the present invention have been described in the preceding paragraphs with reference to various examples, it should be appreciated that modifications to the examples given can be made without departing from the scope of the invention as claimed. For example, phase shifters may be provided at the feed point and the ground point of each antenna element of an antenna arrangement.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
an antenna element having an impedance and a load phase;
a phase shifter coupled to the antenna element; and
a controller for controlling, in response to a change in a context of the apparatus, the phase shifter to compensate for a consequent change in the impedance and load phase of the antenna element.

2. An apparatus as claimed in claim 1, wherein when the apparatus is in a first context the antenna element has a first impedance and a first load phase and when the context of the apparatus changes to a second context, the phase shifter compensates for the consequent change in the impedance and the load phase of the antenna element by bringing the impedance and the load phase of the antenna element towards the first impedance and the first load phase.

3. (canceled)

4. (canceled)

5. An apparatus as claimed in claim 1, further comprising one or more sensors for detecting the context of the apparatus and for providing detection information to the controller for identification of the context of the apparatus.

6. An apparatus as claimed in claim 5, wherein the one or more sensors are operable to detect the proximity of an object which is external to the apparatus.

7. An apparatus as claimed in claim 5, wherein the controller is operable to detect and subsequently identify, using the detection information, the context of the apparatus.

8. (canceled)

9. An apparatus as claimed in claim 5, further comprising a memory for storing a database having information associated with at least one context of the apparatus, and wherein the controller is operable to identify the context of the apparatus by comparing the detection information with the information in the database.

10. An apparatus as claimed in claim 9, wherein the predetermined information in the database includes phase shift information for at least one context.

11. An apparatus as claimed in claim 10, wherein the controller is operable to control the phase shifter using the phase shift information in the database.

12. An apparatus as claimed in claim 1, wherein the phase shifter is coupled to the antenna element via a feed point of the antenna element.

13. An apparatus as claimed in claim 1, wherein the phase shifter is coupled to the antenna element via a ground point of the antenna element.

14. A method comprising:
controlling, in response to a change in a context of an apparatus including an antenna element, having an impedance and a load phase, and a phase shifter coupled to the antenna element, the phase shifter to compensate for a consequent change in the impedance and the load phase of the antenna element.

15. A method as claimed in claim 14, wherein when the apparatus is in a first context the antenna element has a first impedance and a first load phase and when the context of the apparatus changes to a second context, the method further comprises compensating for the consequent change in the impedance and the load phase of the antenna element by bringing the impedance and the load phase of the antenna element towards the first impedance and the first load phase.

16. (canceled)

17. (canceled)

18. A method as claimed in claim 14, further comprising detecting, via one or more sensors, the context of the apparatus and providing information to a controller of the apparatus.

19. A method as claimed in claim 18, further comprising identifying, at the controller, the context of the apparatus using the detected information.

20. A method as claimed in claim 18, wherein the one or more sensors are operable to detect the proximity of an object which is external to the apparatus.

21. (canceled)

22. (canceled)

23. (canceled)

24. A method as claimed in claim 19, further comprising storing a database having information associated with at least one context of the apparatus, and comparing the detection information with the information in the database to identify the context of the apparatus.

25. A method as claimed in claim 24, wherein the predetermined information in the database includes phase shift information for at least one context and wherein the phase shifter is controlled by using the phase shift information in the database.

26. (canceled)

27. (canceled)

28. (Cancelled)

29. (Cancelled)

30. A computer readable storage medium encoded with instructions that, when executed by a controller, perform: controlling, in response to a change in a context of an apparatus, including an antenna element having an impedance and a load phase and a phase shifter coupled to the antenna element, the phase shifter to compensate for a consequent change in the impedance and the load phase of the antenna element.

31. (canceled)

32. (canceled)

33. An apparatus comprising:
an antenna element having a first resonant frequency within a first operational frequency band when in a first context;
a phase shifter coupled to the antenna element; and
a controller for controlling, in response to a change in a context of the apparatus, the phase shifter to change the resonant frequency of the antenna element to a second resonant frequency within the first operational frequency band.

34. (canceled)

35. A computer readable storage medium as claimed in claim 30, wherein when the apparatus is in a first context the antenna element has a first impedance and a first load phase and when the context of the apparatus changes to a second context, and encoded with instructions that, when executed by a controller, perform: the method further comprises compensating for the consequent change in the impedance and the load phase of the antenna element by bringing the impedance and the load phase of the antenna element towards the first impedance and the first load phase.
